(19) United States
(12) Patent Application Publication
(10) Pub. No.: US 2026/0172114 A1
(43) Pub. Date: Jun. 18, 2026

(54) RECONFIGURABLE NETWORK SWITCH SYSTEM AND METHOD

(71) Applicant: Relativity Networks, Inc., Winter Park, FL (US)

(72) Inventor: Jason M. EICHENHOLZ, Orlando, FL (US)

(21) Appl. No.: 19/416,412

(22) Filed: Dec. 11, 2025

Related U.S. Application Data
(60) Provisional application No. 63/734,029, filed on Dec. 13, 2024.

(51) Int. Cl. H04B 10/27; G02B 6/35; H04B 10/077

(52) U.S. Cl. CPC H04B 10/27; G02B 6/3504; G02B 6/3518; H04B 10/0775

(57) ABSTRACT

A method is disclosed that includes a step of dynamically routing, via a reconfigurable cross-connect system, an optical signal, of a plurality of optical signals, onto a hollow-core fiber (HCF) based on a priority associated with the optical signal. Specifically, the optical signal is routed to the HCF when the priority associated with the optical signal is high, or when the optical signal is associated with a high-priority data packet.

### CROSS-REFERENCE TO RELATED APPLICATION

The present application claims the benefit of U.S. Provisional Patent Application 63/734,029 filed on Dec. 13, 2024, which is incorporated herein by reference in its entirety.

### TECHNICAL FIELD

The present disclosure relates generally to network switches, and more specifically to a reconfigurable network switch system and method to route traffic onto or from a hollow core fiber (HCF) via a network switch.

### BACKGROUND OF THE INVENTION

A network switch system, such as an optical cross-connect system or a fiber optic patch panel, is used to route traffic or data packets between two separate hardware assets/elements or servers in a datacenter or between two datacenters. A conventional network switch typically connects two or more optical fibers, and can expand to hundreds or thousands, to route traffic between separate network elements, or more specifically route the “optical paths” associated with the optical signals carried by the optical fibers input into and output from the switch.

There are many known types of switch systems that are used in the telecom or information technology (IT) industry. For example, a conventional patch-panel exists, in which a user manually interconnects or cross-connects input and output fibers/cables to route the traffic. Further, remotely configurable patch-panels also exist, which may be remotely controlled (e.g., via a controller) to efficiently cross-connect optical fibers.

As the demand for telecom services, Internet, voice or video calls, information exchange (e.g., emails, chats, etc.) has exponentially increased over the past few decades, a wide range of technologies has been developed to provide optical cross-connect functionality across hundreds or thousands of optical fibers. Such technologies include, but are not limited to, steerable micro-electromechanical (MEMS) mirrors to deflect optical signals or beams, piezoelectric steerable collimators that direct beams between fibers, robotic cross-connects utilizing actuators that reconfigure fiber optic connections, guided-wave optical switching, and/or the like.

Although the existing telecom systems including the optical fibers, network switches, transceivers, amplifiers, etc. are able to handle the current traffic demands (e.g., speed, bandwidth, etc.) to some extent, newer telecom infrastructure is being developed that offers higher speed, enhanced bandwidth and lower latency. An example of such a telecom infrastructure includes hollow-core fibers (HCF). An HCF offers various benefits over a traditional glass core optical fiber including, but not limited to, a high average and peak power capability, high damage thresholds, low latency, low non-linearities, etc.

A need exists to integrate existing and newer telecom infrastructure to cater to the evolving demands (e.g., higher speed, higher bandwidth, etc.) of individual and enterprise customers/users.

### BRIEF DESCRIPTION OF THE DRAWINGS

Various embodiments of the invention are disclosed in the following detailed description and the accompanying drawings.

FIGS. 1A and 1B depict a block diagram of a reconfigurable network switch system in accordance with one or more embodiments of the present disclosure.

FIG. 2 depicts an example first optical switch in accordance with one or more embodiments of the present disclosure.

FIG. 3 depicts an example second optical switch in accordance with one or more embodiments of the present disclosure.

FIG. 4 depicts an Artificial Intelligence (AI) Agent communicatively coupled with an optical switch in accordance with one or more embodiments of the present disclosure.

FIG. 5 is a flow diagram of a method to route traffic or optical signals onto or from a hollow core fiber (HCF) in accordance with one or more embodiments of the present disclosure.

### SUMMARY

A reconfigurable cross-connect system (“system”) is disclosed in accordance with one or more illustrative embodiments. In some embodiments, the system may be configured to dynamically route a first optical signal, of a plurality of optical signals, onto or from a hollow-core fiber (HCF) based on a priority associated with the first optical signal.

In some embodiments, the system may include a plurality of input ports configured to receive the plurality of optical signals from a plurality of input optical fibers, and a plurality of output ports configured to output the plurality of optical signals to a plurality of output optical fibers. In an exemplary embodiment, one or more optical fibers of the plurality of input optical fibers may include an HCF and the remaining input optical fibers may be non-HCF optical fibers (e.g., conventional telecom optical fibers or solid/glass core fibers). Further, one or more optical fibers of the plurality of output optical fibers may include an HCF and the remaining output optical fibers may be non-HCF optical fibers.

The system may further include a switch configured to switch the plurality of optical signals from the plurality of input ports to the plurality of output ports, to route the plurality of optical signals from the plurality of input optical fibers to the plurality of output optical fibers. The switch may be, for example, a micro-electro-mechanical-system (MEMS) switch, a robotic optical cross-connect switch, a wavelength-selective switch (WSS), a piezoelectric optical switch, and/or the like.

In some embodiments, the switch may be further configured to switch the first optical signal from a first input optical fiber, of the plurality of input optical fibers, to the HCF when the priority associated with the first optical signal is high. The first input optical fiber may itself be an HCF or a non-HCF optical fiber.

In one exemplary embodiment, the priority associated with the first optical signal is high when the first optical signal is associated with a time-sensitive data packet. In a second exemplary embodiment, the priority associated with the first optical signal is high when the first optical signal is associated with a voice data packet. In a third exemplary embodiment, the priority associated with the first optical signal is high when the first optical signal is associated with a 5G or 6G data packet.

In some embodiments, the priority may be associated with one or more of: quality-of-service (QoS), a reliability score or a security score associated with the first optical signal, or a bandwidth.

In some embodiments, the switch may be further configured to switch the first optical signal from the first input optical fiber to the HCF based on a command signal obtained from a controller, which may be part of the system or external to the system. In additional embodiments, the switch may switch the first optical signal from the first input optical fiber to the HCF based on user inputs (e.g., when a user manually switches/connects the first input optical fiber to the HCF). In yet another embodiment, the switch may switch the first optical signal from the first input optical fiber to the HCF based on user-defined criterion/priority.

In further embodiments, the switch may be configured to switch a second optical signal, of the plurality of optical signals, from a second input optical fiber, of the plurality of input optical fibers, to a non-HCF optical fiber when the priority associated with the second optical signal is not high. The second input optical fiber may be an HCF or a non-HCF optical fiber.

In certain embodiments, the HCF may include a mode field adapter configured to enable a connection between the HCF and the switch. In other embodiments, the switch may include a mode field adapter configured to enable a connection between the HCF and the switch.

In one or more additional embodiments of the present disclosure, a method is disclosed that includes a step of dynamically routing, via a reconfigurable cross-connect system, a first optical signal, of a plurality of optical signals, onto a hollow-core fiber (HCF) based on a priority associated with the first optical signal. As described above, the first optical signal is routed to the HCF when the priority associated with the first optical signal is high.

The method may additionally include a step of routing a second optical signal, of the plurality of optical signals, onto a non-HCF optical fiber when the priority associated with the second optical signal is not high. The method may further include a step of routing the first optical signal onto the HCF based on user-defined criterion/priority or based on user inputs.

In yet another embodiment of the present disclosure, a non-transitory computer-readable storage medium is disclosed having instructions stored thereupon which, when executed by a controller, cause the controller to dynamically route an optical signal, of a plurality of optical signals, onto a hollow-core fiber (HCF) based on a priority associated with the optical signal.

### DETAILED DESCRIPTION

The invention can be implemented in numerous ways, including as a process; an apparatus; a system; a combination of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure are directed to reconfigurable network switching systems and methods for routing traffic onto or from a hollow core fiber (HCF) based on a priority associated with the traffic.

It is known that network traffic/data packets are transmitted as optical signals or pulses via optical fibers over long distances. Conventional or standard optical fibers include solid-core optical fibers (or glass core optical fibers) that use wavelength-division multiplexing (WDM) or space-division multiplexing (SDM) to transmit the optical signals. Examples of optical fibers supporting SDM include multimode fibers, multicore fibers, and/or an array of multiple single core fibers.

Another form of optical fiber is a hollow-core optical fiber (HCF), which includes a hollow core and one or more anti-resonant elements. It is known that in the anti-resonant HCFs, light or optical signal is guided in the hollow core as a result of anti-resonant properties of thin walled structures extending along the length of the fiber. Since the light or optical signal is guided in a “hollow” core in an HCF, as opposed to a solid/glass core in the case of a standard optical fiber, the speed of travel of optical signal (and hence the speed of signal transmission) in an HCF is considerably greater than the speed of signal transmission in a solid core optical fiber. Specifically, since the optical signal travels through the hollow core in an HCF, which is essentially vacuum having an index of refraction (“n”) as 1, the optical signal travels through the HCF at a speed that is equivalent to (or substantially equivalent to) the speed of light (as speed of signal in the medium=speed of light (“c”)/n). This is in contrast to the speed of optical signal in a solid/glass core fiber, which typically has an index of refraction in a range of 1.4-1.5, and hence offers a lower speed of transmission of the optical signal.

Further, multi-mode and single-mode solid/glass core fibers are known to operate in O-band, C-band and L-band (e.g., typically between the wavelengths of 1300-1600 nm, and more specifically at a wavelength of 1310 and 1550 nm). The solid/glass core fibers do not operate in further lower wavelengths. On the other hand, HCFs can operate at a wider wavelength range. For example, the HCFs can operate at the wavelengths mentioned above, and can also operate at wavelengths as low as 800 nm. Therefore, HCFs enable signal transmission over a relatively larger wavelength range.

Furthermore, HCF offers various benefits over standard solid core fibers including, but not limited to, high average and peak power capability, high damage thresholds, low latency, low non-linearities, etc. Considering these advantages, many telecom service providers are adopting HCFs for signal transmission, to provide enhanced services to their customers.

Signal transmission via optical fibers is required to be routed between networks, hardware elements, servers, etc. to enable the data/traffic carried by the optical signals to travel from its source location to the destination location. The routing of optical signals is performed at datacenters via one or more network switches, e.g., via optical cross-connect switches or patch-panels. Examples of such network switches include, but are not limited to, micro-electromechanical (MEMS) switches, piezoelectric switches, wavelength-selective switches (WSS), robotic cross-connect switches or patch panels, and/or the like. The term “datacenter”, as used in the present disclosure, may mean any type of processor or processing unit (e.g., a Central Processing Unit (CPU), Graphics Processing Unit (GPU), and/or the like). The network switch described in the present disclosure can route optical signals between any two processors/processing units located at separate physical locations. For example, the network switches can route optical signals between two processors located at different racks in the same room/building, different university campuses, different buildings, etc.

Most of the network switches in the existing datacenters receive optical signals via solid core optical fibers described above. Further, existing infrastructure within a datacenter includes connectors, amplifiers, input/output ports, and other components that are configured to receive optical signals via solid core optical fibers and/or are connectable to solid core optical fibers. However, gradually, solid core optical fibers are being replaced by HCFs or HCFs are being added to existing telecom infrastructure to support high-speed, low-latency signal transmission. Consequently, the existing network switches are being made to receive and/or output optical signals via both solid core optical fibers and HCFs. Stated another way, the existing network switches are configured to route traffic (i.e., the optical signals) from and/or to standard solid core optical fibers as well as HCFs.

Since HCFs support higher-speed, lower-latency signal transmission as compared to standard solid core optical fibers, there exists an opportunity to reconfigure existing network switches to “dynamically” route incoming optical signals to an HCF or to a standard solid core optical fiber (i.e., a non-HCF optical fiber) based on the “priority” of the incoming optical signal. For example, if it is known that an incoming optical signal is associated with time-sensitive data (e.g., financial or market related data) or associated with a voice/video call data packet (irrespective of whether the incoming optical signal is carried by an HCF or a non-HCF fiber), the reconfigured network switch, as disclosed in the present disclosure, may route the optical signal to an HCF. By routing such a “high-priority” optical signal to an HCF, the reconfigured network switch ensures that the optical signal is transmitted via a high-speed, low-latency line or channel (i.e., the HCF), and hence reaches its destination at a faster speed (because of reduced latency). The destination for the optical signal, as described herein, may be another network, a server, a network element, or even a separate datacenter located at a different geographic location. In some aspects, the “priority” of an optical signal may also be Quality-of-Service (QoS) that may be paid for by a system user.

The reconfigured network switch may further route the “regular” optical signals (i.e., the signals that are not associated with high-priority data, e.g., email communication, video streaming, certain application, like high-frequency trading, communications) to a non-HCF fiber, to ensure that the HCF line is not overburdened and the optical fibers are evenly used. In additional embodiments, the reconfigured network switch may route the regular optical signals onto the HCFs, when the non-HCF optical fibers may be running out of capacity.

In further embodiments, the reconfigured network switch may route the optical signals/data packets to or from an HCF based on reliability and security reasons. For example, an incoming optical signal/data packet may be associated with a “reliability” score or a “security” score, and the reconfigured network switch may route the optical signal to an HCF when the score may be greater than a predefined threshold value (which may indicate that the optical signal is associated with a high-security data packet). Alternatively, the reconfigured network switch may route the optical signal to a non-HCF optical fiber when the score may be greater than the predefined threshold value, if the network operator desires to route such signals to a non-HCF optical fiber.

In additional embodiments, the reconfigured network switch may be a wavelength-selective switch that can switch the optical signals between optical fibers associated with different wavelengths, to enable signal transmission at lower wavelengths (e.g., as low as 800 nm, as described above) via HCFs, which is not typically possible via standard optical fibers.

In another scenario, if a datacenter (e.g., a “first datacenter”) having the reconfigured network switch is operating at overcapacity (i.e., receiving a high amount of traffic, but unable to handle the incoming traffic), a telecom infrastructure operator may connect, via a plurality of HCFs, the first datacenter with a second datacenter that may be located at a different geographical location. In this case, the reconfigured network switch may directly route the incoming traffic/optical signals that the first datacenter is not able to handle to the HCFs, so that the optical signals may be transferred at a fast speed to the second datacenter, from where the optical signals may be routed to their respective destinations. In this manner, the reconfigured network switch may enable traffic “load balancing” between different datacenters by using fast-speed signal transmission via HCFs.

It may be appreciated from the description above that the systems and methods disclosed in the present disclosure enable high-priority data packets or optical signals to get routed from or onto an HCF, so that such signals/data packets are transferred at a faster speed and with a lower-latency. This ensures that customer experience is greatly enhanced as data packets associated with voice calls, time-sensitive data, and/or the like, are received securely and at a fast speed by the customers. Furthermore, the systems and methods ensure that the available capacity is optimally utilized, by routing traffic/optical signals onto HCFs when the standard solid core optical fibers may be running out of capacity.

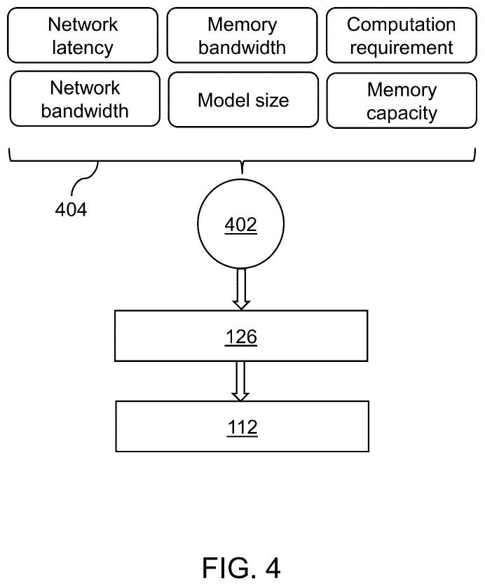

In certain embodiments, artificial intelligence (AI) may prioritize the data packet location between an HCF and a non-HCF optical fiber. In this case, the reconfigured network switch may include or be connected with an AI agent/system that may analyze the data packets/optical signals received by the network switch and the existing packet preferences dictated by traffic managers, and route the data packets based on the data preferences. As an example, the AI agent may route the data packets that may be associated with deep neural networks, LLMs, recommendation engines, and/or the like based on the model's latency-requirements, network bandwidth, latency requirements, etc. Further details of this embodiment are described below in conjunction with FIG. 4.

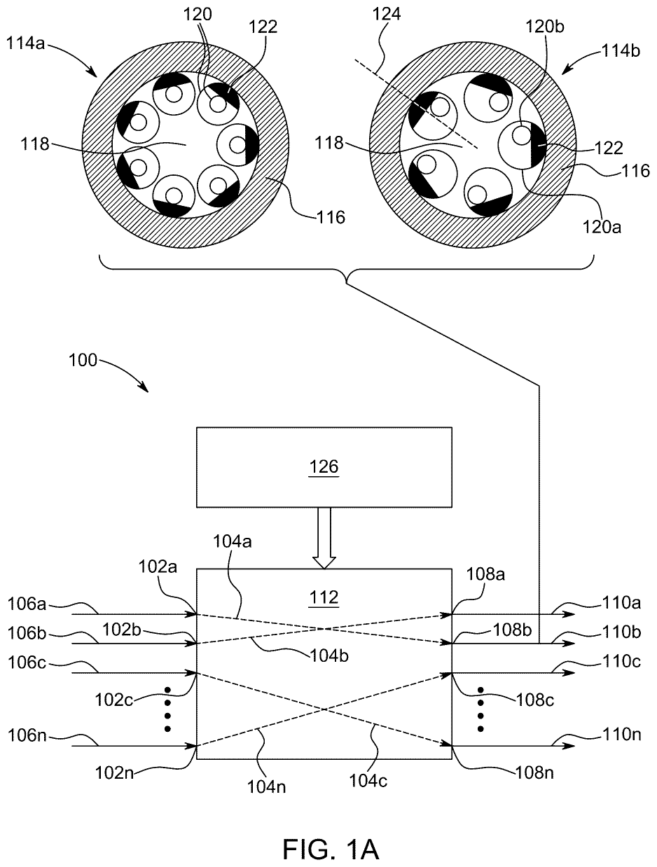

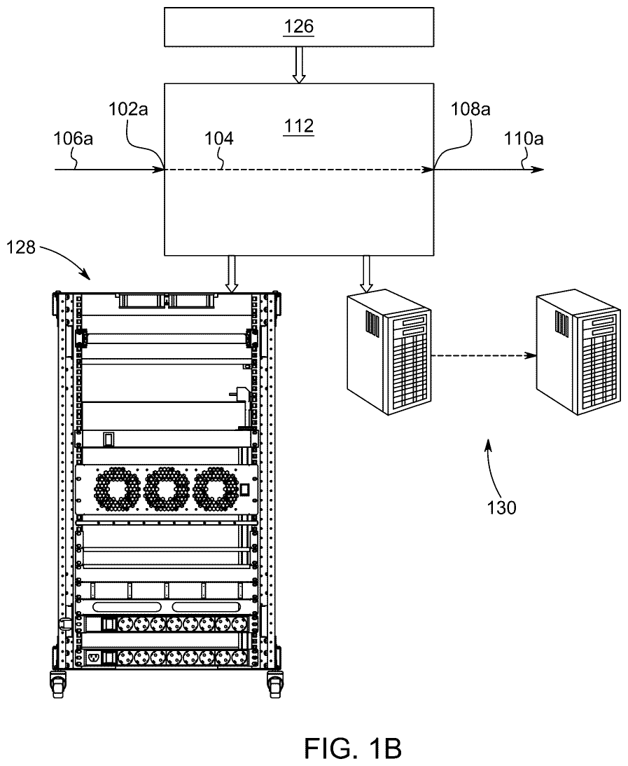

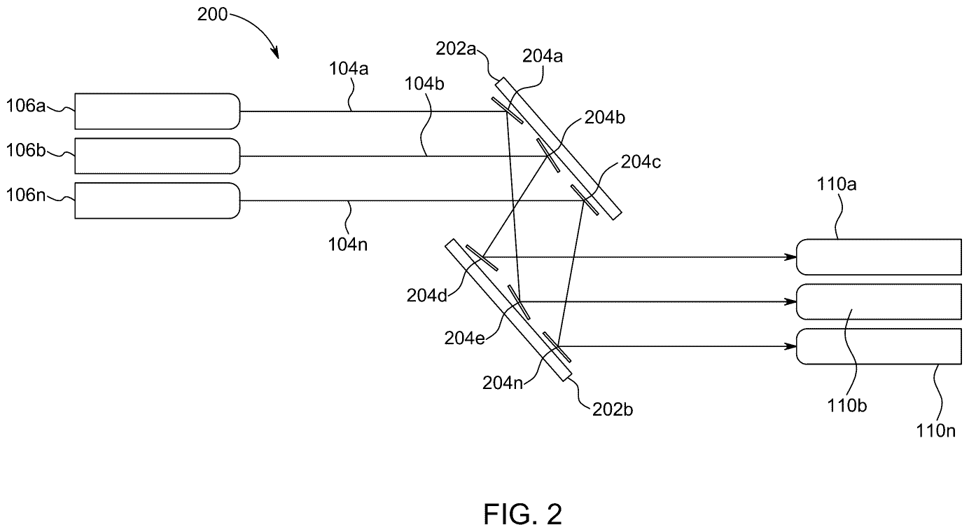

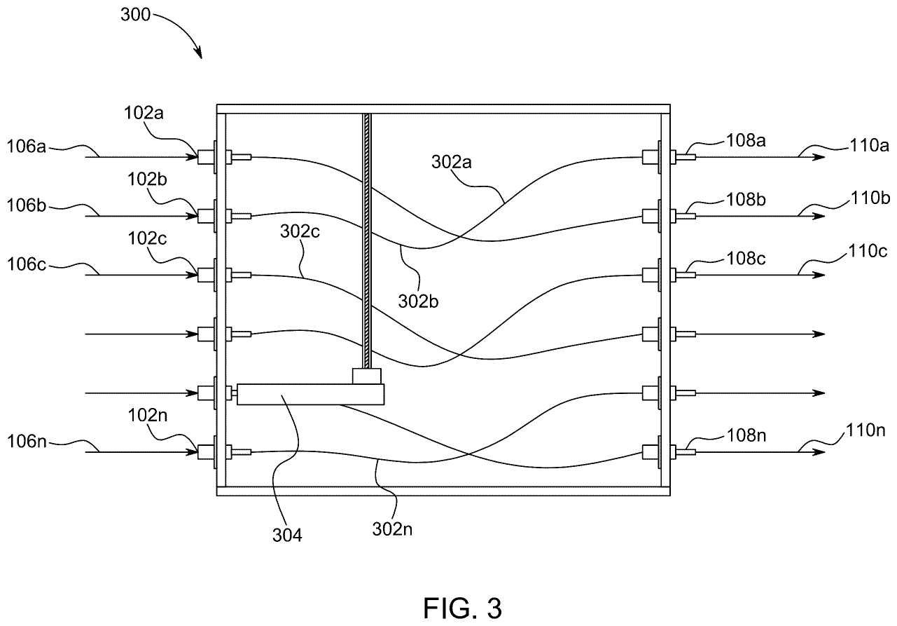

Turning now to the figures, FIGS. 1A and 1B depict a block diagram of a reconfigurable network switch system 100 (or system 100) in accordance with one or more embodiments of the present disclosure. FIGS. 1A and 1B will be described in conjunction with FIGS. 2 and 3. The system 100 may be a cross-connect optical switch system that may be part of a datacenter and configured to dynamically route one or more optical signals, of a plurality of optical signals, onto or from one or more HCFs based on priorities associated with the optical signals.

In some embodiments, as shown in FIG. 1A, the system 100 may include a plurality of input ports 102a, 102b, 102c, 102n (collectively referred to as input ports 102) that may be configured to receive a plurality of optical signals 104a, 104b, 104c, 104n (collectively referred to as optical signals 104) respectively from a plurality of input optical fibers 106a, 106b, 106c, 106n (collectively referred to as input optical fibers 106). The system 100 may further include a plurality of output ports 108a, 108b, 108c, 108n (collectively referred to as output ports 108) configured to output the plurality of optical signals 104 to a plurality of output optical fibers 110a, 110b, 110c, 110n (collectively referred to as output optical fibers 110). A count of the input optical fibers 106 may be the same as or different from a count of the output optical fibers 110. In an exemplary aspect, the counts of the input and output optical fibers 106, 110 may be in a range of hundreds or thousands. In another aspect, the system 100 may include a single input fiber (e.g., the input fiber 106a) and a single output fiber (e.g. the output fiber 110a), as shown in FIG. 1B. Consequently, the system 100 may include one or more input fibers and one or more output fibers, and the configuration depicted in FIG. 1A should not be construed as limiting.

The system 100 may further include a network switch or an optical switch 112 (or switch 112) that may be configured to switch or route one or more optical signals 104 from one or more input ports 102 to one or more output ports 108, to route the optical signals 104 from the input optical fibers 106 to the output optical fibers 110. For example, the switch 112 may route an optical signal from the input port 102a (i.e., from a single input port or a single input fiber) to the output portion 108a (i.e., to a single output port or a single output fiber), as shown in FIG. 1B. As another example, the switch 112 may route multiple optical signals between multiple inputs ports and multiple output ports, as shown in FIG. 1A.

The optical signals 104 may be associated with data packets that the respective input optical fibers 106 may be transmitting, and therefore, the switch 112 may be configured to route the data packets/traffic from the input optical fibers 106 to the output optical fibers 110.

In some aspects, the input optical fibers 106 may be associated with or linked to a first network or one or more first network elements/infrastructure (e.g., first servers), and the output optical fibers 110 may be associated with or linked to a second network or one or more second network elements/infrastructure (e.g., second servers). Consequently, the switch 112 may be configured to route traffic/optical signals between the first network and the second network. The elements/assets of the first network and the elements/assets of the second network may be located within the same geographical location (e.g., within the same building that hosts the datacenter) or may be located at different geographical locations (e.g., separate datacenters that may be located in different cities). For example, the switch 112 may route data packets between processing units/elements located in the same building/room in a server rack as shown in a view 128 of FIG. 1B, or the switch 112 may route data packets between processing units/elements located in separate physical locations (e.g., different buildings, campuses, etc.) as shown in a view 130 of FIG. 1B.

The input optical fibers 106 and the output optical fibers 110 may be substantially the same in design/structure, or may have different designs/structures. In some embodiments, the input optical fibers 106 and the output optical fibers 110 may include a mix of standard solid core (or glass core) optical fibers and hollow-core optical fibers (HCFs). For example, as shown in FIG. 1A, the output optical fiber 110b may be an HCF. Other input and/or output optical fibers 106, 110 may be also HCFs; however, for the sake of simplicity, only the output optical fiber 110b is depicted in FIG. 1A as being an HCF. Such depiction should not be construed as limiting. Further, in the present disclosure, the standard solid core (or glass core) optical fibers are referred to as non-HCF optical fibers.

In some embodiments, the HCF (e.g., the output optical fiber 110b) may include a mode field adapter that may make the HCF compatible with standard network switches, e.g., the switch 112. In other embodiments, the mode field adapter built-in into the HCF may enable the HCF to connect with a standard optical fiber (e.g., a non-HCF optical fiber), which may then connect with a standard network switch (e.g., a MEMS optical switch). In further embodiments, the mode field adapter may be part of the standard network switch, e.g., the switch 112, which may enable the switch 112 to connect with an HCF.

The HCF, as described in the present disclosure, may include a hollow core and one or more anti-resonant elements. It is known that in anti-resonant HCFs, light is guided in the hollow core as a result of anti-resonant properties of thin walled structures extending along the length of the fiber. The HCFs, which are part of the input optical fibers 106 and/or the output optical fibers 110, may have any cross-sectional shape/structure. Two example cross-sectional structures of the HCFs are shown in FIG. 1A as HCFs 114a and 114b.

In some embodiments, the HCF 114a may include one or more cladding structures 116 providing a hollow interior region 118. In the example embodiment depicted in FIG. 1A, the HCF 114a includes a single cladding structure 116 formed as a circular tube. In some embodiments, the HCF 114a may further include multiple AR elements 120 distributed in the hollow interior region 118 provided by the cladding structure 116. As an illustration, the HCF 114a is depicted to include seven sets of nested AR elements 120, where each of the nested AR elements includes one AR element 120 within another AR element 120. In some embodiments, the HCF 114a further includes one or more support structures 122, which may position at least one AR element 120 within the HCF 114a. For example, at least one AR element 120 may be connected to at least one support structure 122. The support structures 122 may generally be formed as or be in contact with the cladding structure 116 and/or any of the AR elements 120.

In further embodiments, the HCF 114b may be substantially similar in structure to the HCF 114a, except that a single “offset” second AR element 120b may be located within the interior region of a first AR element 120a. Stated another way, the second AR elements 120b are not symmetrically placed within the first AR elements 120a and are thus not centered on a radial line 124 from the center of the HCF 114b.

The example cross-sectional structures of the HCFs 114a, 114b depicted in FIG. 1A should not be construed as limiting. The cross-sectional structures of the HCF 114a, 114b are depicted in FIG. 1A just for illustrative purpose, and the HCFs included in the input optical fibers 106 and/or the output optical fibers 110 may have different cross-sectional structures, without departing from the scope of the present disclosure. Further example HCF cross-sectional structures are depicted in the U.S. patent application Ser. No. 18/662,573, filed on May 13, 2024, which is incorporated by reference in its entirety in the present disclosure.

The switch 112 may be any switch that may be configured to efficiently route the traffic/optical signals from the input optical fibers 106 to the output optical fibers 110. For example, the switch 112 may be a micro-electro-mechanical-system (MEMS) switch, a robotic optical cross-connect switch, a wavelength-selective switch (WSS), a piezoelectric optical switch, and/or the like.

An example MEMS switch 200 (which may be same as the switch 112) is depicted in FIG. 2. In some embodiments, the MEMS switch 200 may include one or more MEMS mirror arrays 202a, 202b including a plurality of mirrors 204a, 204b, 204c, 204d, 204e, 204n (collectively referred to as mirrors 204) that may be configured to route the optical signals 104 (and hence the traffic) from the input optical fibers 106 to the output optical fibers 110. Specifically, based on an angle of inclination of each mirror 204 relative to an incoming optical signal 104, the MEMS switch 200 may route the optical signal 104 between the input optical fiber 106 and the output optical fiber 110.

For example, as shown in FIG. 2, the optical signal 104a transmitted by the input optical fiber 106a may fall onto the mirror 204a. Based on the angles of inclination of the mirror 204a relative to the optical signal 104a and the mirrors on the array 202b, the mirror 204a may reflect the optical signal 104a onto the mirror 204e. Further, based on the angles of inclination of the mirror 204e relative to the optical signal 104a reflected from the mirror 204a and the output optical fibers 110 (specifically relative to the output ports to which the output optical fibers 110 may be connected), the mirror 204e may reflect the optical signal 104a to the output optical fiber 110b.

By changing the angles of inclination described above, the optical signal 104a may get routed to any of the output optical fibers 110. In this manner, the MEMS switch 200 routes optical signals 104 (and hence the traffic) from the input optical fibers 106 to the output optical fibers 110. In an exemplary embodiment, the angles of inclination of each mirror 204 may be dynamically and remotely adjusted by a system operator (or a computing device) by transmitting command signals to the MEMS switch 200 via a controller (e.g., a controller 126 depicted in FIG. 1 and described later in the description below). In this manner, the traffic may be routed from the input optical fibers 106 to the output optical fibers 110 by using the MEMS switch 200 and the controller.

Structures and operations of MEMS switches (e.g., the MEMS switch 200) is known in the art, and hence not described here in the present disclosure in detail.

An example robotic optical cross-connect switch 300 (which may be same as the switch 112) is depicted in FIG. 3. The switch 300 may include a plurality of connecting fibers/cables 302a, 302b, 302c, 302n (collectively referred to as connecting fibers 302) that may be used to connect the input ports 102 (and hence the input optical fibers 106) with the output ports 108 (and hence the output optical fibers 110). The switch 300 may further include a robotic arm or gripper 304 that may be configured to move in 3-dimensional space in the switch 300, and “grab” or “pick” proximal and/or distal ends of the connecting fibers 302 and attach them to the input ports 102 or the output ports 108 to cross-connect the input optical fibers 106 and the output optical fibers 110, thereby routing the traffic from the input optical fibers 106 to the output optical fibers 110. For example, the gripper 304 may grab and connect a proximal end of the connecting fiber 302a with the input port 102a (and hence to the input optical fiber 106a). If the distal end of the connecting fiber 302a is connected to the output port 108b (and hence to the output optical fiber 110b), the switch 300 may enable the connection of the input optical fiber 106a with the output optical fiber 110b by making the gripper 304 connect the proximal end of the connecting fiber 302a with the input port 102a, thereby enabling the flow of traffic/optical signals from the input optical fiber 106a to the output optical fiber 110b.

In some embodiments, the movement of the gripper 304 within the 3-D space of the switch 300 and the actions of gripping and attaching the connecting fibers 302 with the input/output ports 102, 108 may be triggered/controlled by the controller described above. In additional or alternative aspects, the movement and actions of the gripper 304 may be executed manually by a user or a system operator.

Structures and operations of robotic cross-connect switches (e.g., the robotic optical cross-connect switch 300) is known in the art, and hence not described here in the present disclosure in detail.

As described above, the switch 112 may also be a wavelength-selective switch (WSS). It is known that standard optical fibers (e.g., non-HCF optical fibers) operate in O-band, C-band and L-band (e.g., typically between the wavelengths of 1300-1600 nm), and the HCFs can operate at a wider wavelength range. For example, the HCFs can operate at the wavelengths mentioned above, and can also operate at wavelengths as low as 800 nm. The switch 112 may route the optical signals between optical fibers associated with different wavelengths, to enable signal transmission at lower wavelengths (e.g., as low as 800 nm) via HCFs, which is not typically possible via standard optical fibers. In this manner, the switch 112 enables bandwidth optimization by using lower wavelengths, which was conventionally not possible in infrastructure including only standard optical fibers and no HCFs.

The examples of the switch 112 as the MEMS switch 200, the robotic optical cross-connect switch 300 and WSS depicted in FIGS. 2 and 3 and described above should not be construed as limiting. The switch 112 may be any other type of network switch that may be configured to route traffic between the input and output optical fibers 106, 110 (that may include a mix of HCFs and non-HCF optical fibers), without departing from the scope of the present disclosure. Stated another way, the systems and methods disclosed in the present disclosure may be applicable to any type of network switch, and the examples of the network switches described in the present disclosure should not be construed as limiting.

In operation, the switch 112 may be configured to switch the optical signals 104 from the input optical fibers 106 to the output optical fibers 110 based on the priorities associated with the optical signals 104. Specifically, the switch 112 may be configured to switch an optical signal with a high priority to an HCF, and may switch an optical signal that may not be of high priority to a non-HCF optical fiber.

For example, the switch 112 may switch or route the optical signal 104a carried by the input optical fiber 106a to the output optical fiber 110b (that may be an HCF) when the priority associated with the optical signal 104a may be high. In some aspects, the priority associated with the optical signal 104a may be high when the optical signal 104a may be associated with a time-sensitive data packet, a voice data packet, a 5G or 6G data packet, and/or the like. In additional aspects, the priority associated with the optical signal 104a may be high when the “reliability” score or the “security” score associated with the signal may be high, indicating that the data packet is a high-security data packet. In further aspects, as described above, the switch 112 may route the optical signal 104a to the output optical fiber 110b when the optical signal 104a is to be routed to a low bandwidth or low-priority channel. In additional aspects, the “priority” of an optical signal may also be associated with Quality-of-Service (QoS) that may be paid for by a system user. For example, an optical signal may be considered to have a high priority if higher QoS is paid for the data packet/optical signal by a system user.

In some embodiments, the switch 112 may switch or route the optical signals 104 (e.g., the optical signal 104a) from the input optical fibers 106 (e.g., the input optical fiber 106a) to the output optical fibers 110 (e.g., the output optical fiber 110b) based on command signals obtained from the controller 126 (which may be part of the system 100 or external to the system 100).

In one exemplary embodiment, the controller 126 may pre-store an information or a data structure including a mapping of the input optical fibers 106 with a priority level (e.g., High, Medium, Low) of optical signals/traffic carried by each input optical fiber, and may use this data structure to transmit command signals to the switch 112 to route the traffic between the input and output optical fibers 106, 110, based on the respective priority levels. For example, the controller 126 may have a pre-stored information indicating that the optical signal 104a may be associated with a high-priority data packet (and the remaining optical signals 104 may be associated with medium and/or low priority data packets). The controller 126 may use this information to transmit a command signal to the switch 112, to cause the switch 112 to route the optical signal 104a onto an HCF (i.e., the output optical fiber 110b) to enable faster and low-latency based signal transmission of the optical signal 104a. In this manner, the controller 126 ensures that the optical signal 104a (that is associated with high-priority data) is given “preferential treatment”, and is routed to a high-speed optical fiber (i.e., the HCF) as opposed to the standard solid/glass core optical fiber (i.e., a non-HCF fiber).

In a second exemplary embodiment, the controller 126 may not “pre-store” the information or data structure described above, but may receive such information in real-time from an external server or computing device (not shown) that may be associated with a telecom service operator. In this case also, the controller 126 causes the switch 112 to route the traffic/optical signals 104 based on their respective priorities, as described above. In further embodiments, the controller 126 may include or be communicatively coupled with an AI agent that may enable the controller 126 to route optical signals 104 between the input and output optical fibers 106, 110 (e.g., between HCFs and non-HCF optical fibers) based on existing packet preferences dictated by traffic managers/telecom service operators. This embodiment is described later below in conjunction with FIG. 4.

In another embodiment, the switch 112 may route the traffic/optical signals 104 (e.g., the optical signal 104a) based on user inputs or manual actions. For example, a system operator may manually connect the input optical fiber 106a with the output optical fiber 110b (via the connecting fiber 302 described above), and hence to an HCF, when it is known to the system operator that the optical signal 104a is associated with high priority data.

In yet another embodiment, the switch 112 may route the traffic/optical signals 104 (e.g., the optical signal 104a) based on user-defined criterion/priority that may be pre-stored in the controller 126. For example, if the user-defined criterion indicates that the optical signal 104a will carry high priority data for a predefined time duration, the switch 112 (based on the command signals obtained from the controller 126) may route the optical signal 104a to an HCF (i.e., the output optical fiber 110b) for the predefined time duration.

The switch 112 may be further configured to route regular traffic/optical signals (i.e., the optical signals not associated with high priority data) to non-HCF optical fibers. For example, the switch 112 may route the optical signal 104b to the output optical fiber 110a (which may be a non-HCF optical fiber), when the priority associated with the optical signal 104b may not be high or the optical signal 104b may not be associated with high priority data (e.g., associated with email or chat data).

As described above, in some embodiments, the switch 112 may still route the regular traffic/optical signals to the HCFs, when the non-HCF optical fiber may be running out of capacity.

In some embodiments, the controller 126, as described above, may be communicatively coupled with the switch 112 and one or more external servers/computing devices (not shown). The controller 126 may include one or more processors configured to execute a set of program instructions maintained in a controller memory (not shown). The processors may include any microprocessor-type device configured to execute algorithms and/or instructions. The processors may include one or more processing or logic elements (e.g., one or more micro-processor devices, one or more application specific integrated circuit (ASIC) devices, one or more field programmable gate arrays (FPGAs), or one or more digital signal processors (DSPs)).

In some embodiments, the processors are formed as or integrated within a desktop computer, mainframe computer system, workstation, image computer, parallel processor, networked computer, or any other computer system configured to execute program instructions. Further, the steps described throughout the present disclosure may be carried out by a single controller or, alternatively, multiple controllers. Additionally, the controller 126 may include one or more controllers housed in a common housing or within multiple housings.

The controller memory may include any storage medium known in the art suitable for storing program instructions executable by the associated processors. For example, the controller memory may include a non-transitory memory medium. By way of another example, the controller memory may include, but is not limited to, a read-only memory (ROM), a random-access memory (RAM), a magnetic or optical memory device (e.g., disk), a magnetic tape, a solid-state drive and the like. It is further noted that the controller memory may be housed in a common controller housing with the processors. In some embodiments, the controller memory may be located remotely with respect to the physical location of the processors and the controller 126. For instance, the processors of the controller 126 may access a remote memory (e.g., server), accessible through a network (e.g., internet, intranet and the like).

FIG. 4 depicts an Artificial Intelligence (AI) agent 402 communicatively coupled with the switch 112 in accordance with one or more embodiments of the present disclosure. In the exemplary aspect depicted in FIG. 4, the AI agent 402 is communicatively coupled with the switch 112 via the controller 126. For the sake of simplicity, the optical signals 104, the input and output optical fibers 106, 110, etc. are not shown in FIG. 4.

In some aspects, the AI agent 402 may be part of the controller 126. In other aspects, the AI agent 402 may be hosted on a server or a distributed computing system, which may be communicatively coupled with the controller 126. The AI agent 402 may be configured to analyze the data packets/optical signals 104 received by the switch 112 and existing packet preferences 404 (or data preferences 404) dictated by traffic managers, and route the data packets between the input and output optical fibers 106, 110 (via the controller 126) based on the data preferences 404. In an exemplary aspect, the AI agent 402 may be used to dynamically analyze the data packets and route the data packets onto or from the HCFs, when the traffic of data packets may be high, e.g., when the data is being transferred for Machine Learning (ML) algorithms/systems, deep neural network systems/algorithms, LLMs, recommendation engines, etc., as described below. Examples of the data preferences 404 include, but are not limited to, network latency, memory bandwidth, computational bandwidth, network bandwidth, model size, memory capacity, and/or the like.

It is known that ML algorithms/systems use and exchange large quantities of data. To enable efficient exchange of this large quantity of data, it is imperative that the network infrastructure optimally routes data packets. The AI agent 402 may optically route data packets based on the data preferences 404, and the types of tasks that are expected to be performed by the data carried by the data packets.

It is known that the use of data by ML systems/models varies widely based on the model's computational needs, data transfer requirements, communication patterns, and/or the like. Some systems, such as deep neural networks, require large amounts of data to be transferred between nodes in a distributed computing environment. Others, such as recommendation models, may require low-latency communication for real-time decision-making. Additionally, the computational intensity of different models may vary significantly, impacting the bandwidth and the processing power required. For example, an LLM may require more computational power, network bandwidth and network latency, but less memory bandwidth. On the other hand, a recommendation engine may require more memory bandwidth and capacity, and relatively moderate network latency.

Based on the data preferences 404 set by the traffic managers and/or the type of ML system for which the data may be used, the AI agent 402 may dynamically analyze the received data packets and automatically route the data packets between the input and output optical fibers 106, 110. For example, the AI agent 402 may route, via the controller 126 and the switch 112, a data packet associated with an LLM onto an HCF due to latency requirements.

The AI agent 402 may dynamically route the data packets onto or from an HCF based on the data preferences 404 to optimize bandwidth allocation, latency requirements, system scalability, and/or the like. For example, the AI agent 402 may route the data packets such that sufficient bandwidth is allocated to meet the diverse needs of different ML models. As another example, the AI agent 402 may route the data packets such that low latency for time-sensitive ML applications is ensured.

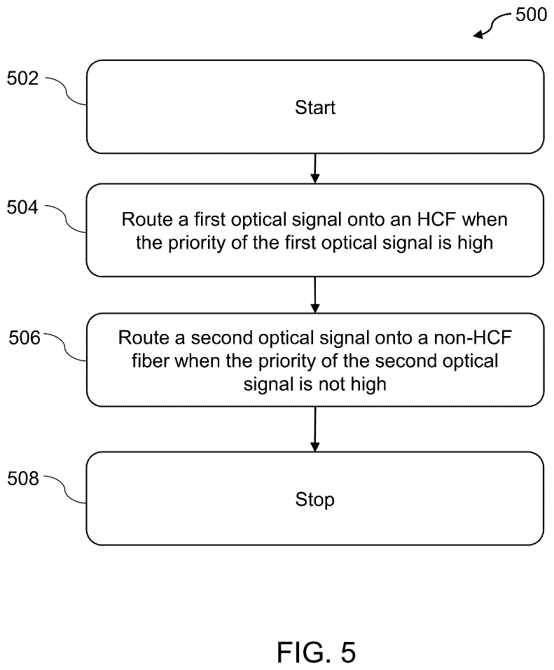

FIG. 5 is a flow diagram of a method 500 to route traffic or optical signals onto or from a hollow core fiber (HCF) in accordance with one or more embodiments of the present disclosure. Applicant notes that the embodiments and enabling technologies described previously herein in the context of the system 100 should be interpreted to extend to the method 500. It is further noted, however, that the method 500 is not limited to the architecture/structure/operation of the system 100 described above.

The method 500 may start at step 502. At step 504, the method 500 may include routing a first optical signal (e.g., the optical signal 104a) onto an HCF (e.g., the output optical fiber 110b) when the priority associated with the first optical signal is high or the first optical signal is associated with a high-priority data packet, as described above.

At step 506, the method 500 may include routing a second optical signal (e.g., the optical signal 104b) onto a non-HCF optical fiber (e.g., the output optical fiber 110a) when the priority associated with the second optical signal is not high.

The method 500 may end at step 508.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments in the present disclosure have been described in some detail for purposes of clarity of understanding, the invention is not limited to the details provided. There are many alternative ways of implementing the invention. The disclosed embodiments are illustrative and not restrictive.

What is claimed is:

1. A method comprising a step of dynamically routing, via a reconfigurable cross-connect system, a first optical signal, of a plurality of optical signals, onto a hollow-core fiber (HCF) based on a priority associated with the first optical signal.

2. The method of claim 1, wherein the first optical signal is routed to the HCF when the priority associated with the first optical signal is high.

3. The method of claim 2, wherein the priority associated with the first optical signal is high when the first optical signal is associated with at least one of a time-sensitive data packet, a voice data packet, or a 5G or 6G data packet.

4. The method of claim 1 further comprising a step of routing a second optical signal, of the plurality of optical signals, onto a non-HCF optical fiber when a priority associated with the second optical signal is not high.

5. The method of claim 1 further comprising a step of routing the first optical signal onto the HCF based on user-defined criterion.

6. The method of claim 1, wherein the priority is associated with one or more of: quality-of-service (QoS), a reliability score or a security score associated with the first optical signal, or a bandwidth.

7. A reconfigurable cross-connect system configured to dynamically route a first optical signal, of a plurality of optical signals, onto a hollow-core fiber (HCF) based on a priority associated with the first optical signal.

8. The reconfigurable cross-connect system of claim 7, wherein the system comprises:
a plurality of input ports configured to receive the plurality of optical signals from a plurality of input optical fibers; and
a plurality of output ports configured to output the plurality of optical signals to a plurality of output optical fibers, wherein the plurality of output optical fibers comprises the HCF and one or more non-HCF optical fibers.

9. The reconfigurable cross-connect system of claim 8, further comprising a switch configured to switch the plurality of optical signals from the plurality of input ports to the plurality of output ports to route the plurality of optical signals from the plurality of input optical fibers to the plurality of output optical fibers.

10. The reconfigurable cross-connect system of claim 9, wherein the switch is further configured to switch the first optical signal from a first input optical fiber, of the plurality of input optical fibers, to the HCF when the priority associated with the first optical signal is high.

11. The reconfigurable cross-connect system of claim 10, wherein the priority associated with the first optical signal is high when the first optical signal is associated with at least one of a time-sensitive data packet, a voice data packet, or a 5G or 6G data packet.

12. The reconfigurable cross-connect system of claim 9, wherein the switch is further configured to switch a second optical signal, of the plurality of optical signals, from a second input optical fiber, of the plurality of input optical fibers, to a non-HCF optical fiber when the priority associated with the second optical signal is not high.

13. The reconfigurable cross-connect system of claim 9, further comprising a controller, wherein the switch switches the first optical signal based on a command signal obtained from the controller.

14. The reconfigurable cross-connect system of claim 9, wherein the switch switches the first optical signal based on user inputs.

15. The reconfigurable cross-connect system of claim 9, wherein the switch is at least one of a micro-electro-mechanical-system (MEMS) switch, a robotic optical cross-connect switch, a wavelength-selective switch (WSS), or a piezoelectric optical switch.

16. The reconfigurable cross-connect system of claim 9, wherein the switch comprises a mode field adapter configured to enable a connection between the HCF and the switch.

17. The reconfigurable cross-connect system of claim 7, wherein the priority is associated with one or more of: quality-of-service (QoS), a reliability score or a security score associated with the first optical signal, or a bandwidth.

18. The reconfigurable cross-connect system of claim 7, wherein the HCF comprises a mode field adapter configured to enable a connection between the HCF and a network switch.

19. A non-transitory computer-readable storage medium having instructions stored thereupon which, when executed by a controller, cause the controller to dynamically route an optical signal, of a plurality of optical signals, onto a hollow-core fiber (HCF) based on a priority associated with the optical signal.

20. The non-transitory computer-readable storage medium of claim 19, wherein the optical signal is routed to the HCF when the priority associated with the optical signal is high.
